(19) United States
(12) Patent Application Publication
(10) Pub. No.: US 2026/0067706 A1
(43) Pub. Date: Mar. 5, 2026

(54) WI-FI SURVEY COMBINED WITH PHYSICAL MAPPING

(71) Applicant: Ruckus IP Holdings LLC, Claremont, NC (US)

(72) Inventor: Peter G. Khoury, San Francisco, CA (US)

(73) Assignee: Ruckus IP Holdings LLC, Claremont, NC (US)

(21) Appl. No.: 19/311,204

(22) Filed: Aug. 27, 2025

Related U.S. Application Data
(60) Provisional application No. 63/687,941, filed on Aug. 28, 2024.

(51) Int. Cl. H04W 16/20; H04B 17/391; H04W 4/38; H04W 84/12

(52) U.S. Cl. CPC H04W 16/20; H04B 17/3912; H04W 4/38; H04W 84/12

(57) ABSTRACT

During operation, an electronic device may generate, using an image sensor, a 2D or a 3D map of a physical layout of an environment. Then, based at least in part on the 2D or 3D map of the physical layout of the environment, the electronic device may determine a path of the electronic device in the environment. Moreover, the electronic device may perform a wireless scan, where the wireless scan is performed concurrently with motion of the electronic device along the path. Next, based at least in part on the wireless scan, the electronic device may generate a wireless-performance map of wireless performance along the path. Furthermore, based at least in part on the 2D or 3D map of the physical layout of the environment, the electronic device may interpolate the wireless-performance map to determine the wireless performance in a 2D plane in the environment.

### CROSS REFERENCE TO RELATED APPLICATIONS

This application claims priority under 35 U.S.C. 119(e) to U.S. Provisional Application Ser. No. 63/687,941, “Wi-Fi Survey Combined with Physical Mapping,” filed on Aug. 28, 2024, by Peter G. Khoury, the contents of which are herein incorporated by reference.

### FIELD

The described embodiments relate to techniques for combining two-dimensional (2D) or three-dimensional (3D) physical mapping of an environment with a Wi-Fi survey to generate a 2D heat map of Wi-Fi performance in the environment.

### BACKGROUND

Many electronic devices are capable of wirelessly communicating with other electronic devices. For example, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard (which is sometimes referred to as ‘Wi-Fi’), Bluetooth™ from the Bluetooth Special Interest Group of Kirkland, Washington), and/or another type of wireless network.

Existing approaches to performing a survey of the Wi-Fi performance of a wireless local area network (WLAN) in an environment (such as in a building) typically use specialized hardware. However, this often increases the cost, complexity and expense of the survey.

For example, existing survey tools may continuously gather data as a survey taker wanders around an environment. However, these measurements usually are not tied to a physical location. Consequently, whether the entire environment has been covered or whether some parts of the environment have been covered redundantly is typically unknown. Moreover, in order to generate a heat map of the environment, a floor plan may ne needed. These are often hard and expensive to generate.

Moreover, when the survey taker has a floor plan, they may manually acquire measurements and may note where each measurement is on the floor plan. However, this approach is often very tedious, slow and expensive. In addition, the survey may use specialized (and, thus, expensive) tools, and the measurements may not accurately reflect the Wi-Fi performance of real-world electronic devices. This may reduce the relevance or accuracy of the survey.

### SUMMARY

An electronic device is described. This electronic device includes: an image sensor that acquires one or more images of an environment; and an interface circuit that communicates using wireless communication with one or more access points in a WLAN. During operation, the electronic device generates, using the image sensor, a 2D or a 3D map of a physical layout of the environment. Then, based at least in part on the 2D or 3D map of the physical layout of the environment, the electronic device determines a path of the electronic device in the environment. Moreover, the electronic device performs a wireless scan, where the wireless scan is performed concurrently with motion of the electronic device along the path. Next, based at least in part on the wireless scan, the electronic device generates a wireless-performance map of wireless performance along the path. Furthermore, based at least in part on the 2D or 3D map of the physical layout of the environment, the electronic device interpolates the wireless-performance map to determine wireless performance in a 2D plane in the environment.

Note that the electronic device may include a cellular telephone.

Moreover, the electronic device may include a LiDAR sensor or an accelerometer, and the electronic device may generate the 2D or 3D map of the physical layout of the environment using the LiDAR sensor or the accelerometer.

Furthermore, the wireless communication may be compatible with an IEEE 802.11 communication protocol.

Additionally, during the wireless scan, the electronic device may communicate with at least one of the one or more access points. For example, the electronic device may provide a probe request or a packet to at least the one of the one or more access points.

In some embodiments, during the wireless scan, the electronic device may acquire information specifying wireless signal strength (such as a received signal strength indication or RSSI) for packets as a function of time. For example, the electronic device may receive reports associated with the one or more access points with the information for the packets received by the one or more access points from the electronic device. Alternatively or additionally, the packets may be received by the electronic device from the one or more access points.

Note that, during the wireless scan, the electronic device may instruct the one or more access points to use a common channel. Moreover, the electronic device may instruct the one or more access points to operate in a promiscuous mode.

Furthermore, generating the wireless-performance map of wireless performance along the path may include receiving the wireless-performance map of wireless performance along the path from a computer system (such as a cloud-based computer system). Additionally, the electronic device may provide results of the wireless scan to the computer system, which may be used by the computer system to generate the wireless-performance map of wireless performance along the path.

In some embodiments, in response to receiving information specifying an access point in the one or more access points, the electronic device may determine a location of the access point based at least in part on the 2D or 3D map and distances to at least two other access points in the access points.

Note that the wireless performance in the 2D plane in the environment may exclude reflections. Moreover, the wireless performance in the 2D plane in the environment may include signal strength (such as RSSI) as a function of location in the 2D plane.

Another embodiment provides the access point.

Another embodiment provides the computer system, which may perform some of the operations of the electronic device or one or more corresponding counterpart operations.

Another embodiment provides a computer-readable storage medium for use with the access point, the electronic device or the computer system. This computer-readable storage medium may include program instructions that, when executed by the access point, the electronic device or the computer system, cause the access point, the electronic device or the computer system to perform at least some of the aforementioned operations.

Another embodiment provides a method. This method includes at least some of the operations performed by the access point, the electronic device or the computer system.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example method for determining wireless performance in a 2D plane in an environment in accordance with an embodiment of the present disclosure.

FIG. 3A is a drawing illustrating an example of communication among electronic devices in FIG. 1 in accordance with an embodiment of the present disclosure.

FIG. 3B is a drawing illustrating an example of communication among electronic devices in FIG. 1 in accordance with an embodiment of the present disclosure.

FIG. 4 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device is described. This electronic device may generate, using an image sensor, a 2D or a 3D map of a physical layout of an environment. Then, based at least in part on the 2D or 3D map of the physical layout of the environment, the electronic device may determine a path of the electronic device in the environment. Moreover, the electronic device may perform a wireless scan, where the wireless scan is performed concurrently with motion of the electronic device along the path. Next, based at least in part on the wireless scan, the electronic device may generate a wireless-performance map of wireless performance along the path. Furthermore, based at least in part on the 2D or 3D map of the physical layout of the environment and the map of wireless performance, the electronic device may interpolate the wireless-performance map to determine the wireless performance in a 2D plane in the environment.

By generating the 2D or 3D map of the physical layout of the environment and determining the wireless performance in the 2D plane in the environment, these communication techniques may reduce the cost, complexity and time associated with performing the survey of wireless performance in the environment. Consequently, the communication techniques may provide an improved user experience and may facilitate improved communication performance of a WLAN in the environment.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi, LTE and Ethernet are used as illustrative examples.

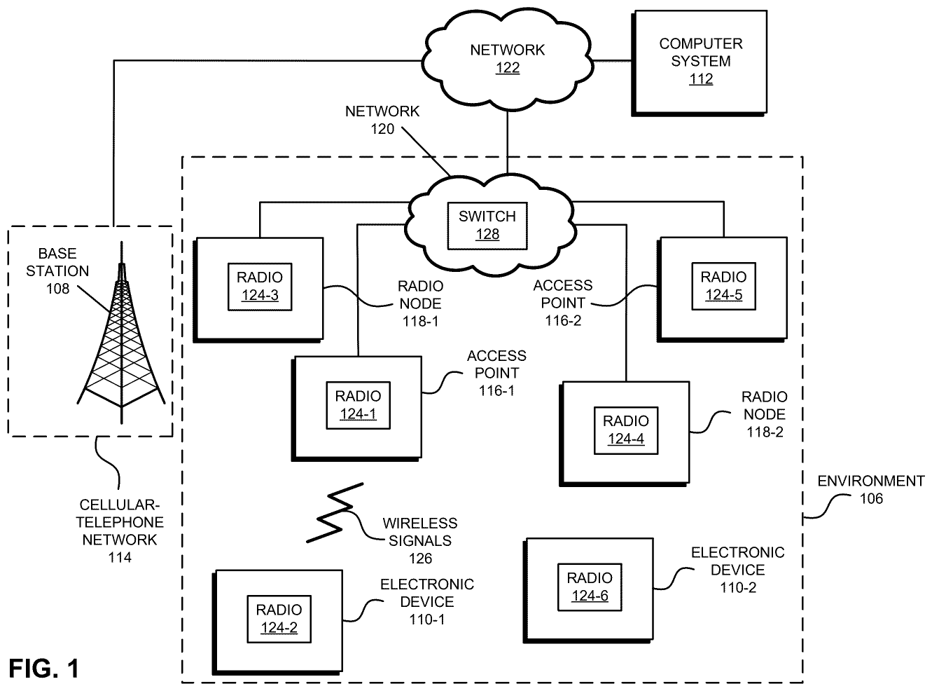

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc.) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, as noted previously, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or optional computer system 112 (which may include one or more computers, and which may be a local or cloud-based controller that manages and/or configures access points 116, radio nodes 118 and/or switch 128, or a cloud-based computer system that provides cloud-based storage and/or analytical services) using a wired communication protocol (such as Ethernet) via network 120 and/or 122. Note that networks 120 and 122 may be the same or different networks. For example, networks 120 and/or 122 may an LAN, an intra-net or the Internet. In some embodiments, network 120 may include one or more routers and/or switches (such as switch 128).

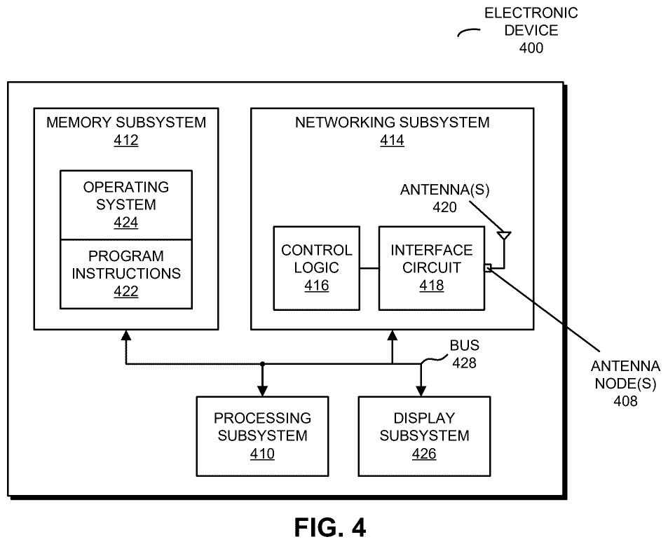

As described further below with reference to FIG. 4, electronic devices 110, computer system 112, access points 116, radio nodes 118 and switch 128 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA) and/or multiple input, multiple output (MIMO).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, it can be complicated, expensive and time-consuming to perform a survey of wireless performance in environment 106. In order to address these problems, an electronic device (such as electronic device 110-1, which may be a cellular telephone) may perform the disclosed communication techniques. During operation, electronic device 110-1 may generate, using an image sensor, an accelerometer and/or a LiDAR sensor in electronic device 110-1, a 2D or a 3D map of a physical layout of environment 106. For example, electronic device 110-1 may acquire images of environment 106 and a location of electronic device 110-1 when the images are acquired. For example, the location may be determined using communication with a cellular-telephone network and/or a Global Positioning System (GPS). In some embodiments, the location may be determined with an accuracy of one or more inches or one or more feet. Notably, the location may be determined using one or more acquired images (e.g., using image analysis and/or a pretrained neural network, such as a convolutional neural network or CNN) and/or measurements in environment 106 (such as accelerometer and/or LiDAR measurements). Moreover, electronic device 110-1 may combine the images based at least in part on perspectives when the images were acquired into the 2D or a 3D map of the physical layout of environment 106. In some embodiments, electronic device 110-1 may generate the 2D or 3D map of the physical layout of environment 106 using a pretrained neural network, such as a convolutional neural network that takes the images as inputs and outputs the 2D or 3D map of the physical layout of environment 106.

Then, based at least in part on the 2D or 3D map of the physical layout of environment 106, electronic device 110-1 may determine a path of electronic device 110-1 in environment 106. For example, electronic device 110-1 may determine its location, as a function of time, using communication with the cellular-telephone network and/or the Global Positioning System. However, in other embodiments, positioning or tine synchronization may not be used. Instead, an accurate (but not externally synchronized) clock may be used.

Moreover, electronic device 110-1 may perform a wireless scan (which may involve communication that is compatible with an IEEE 802.11 standard), where the wireless scan is performed concurrently with motion of electronic device 110-1 along the path. For example, the wireless scan may include communicating with one or more of access points 116. This communication may include passive listening for communication from the one or more of access points 116, such as receive one or more beacons from the one or more of access points 116. Alternatively, the communication may include active communication, such as when electronic device 110-1 provides a packet or frame (such as a probe request) to the one or more of access points 116, and may include receiving a response (such as a probe response) from a given one of the one or more of access points 116. In some embodiments, the passive listening may be performed by one of access points 116 (instead of by electronic device 110-1).

Moreover, during the wireless scan, electronic device 110-1 may acquire information specifying wireless signal strength (such as RSSI) for packets as a function of time. For example, electronic device 110-1 may receive reports associated with the one or more of access points 116 with the information for the packets or frames received by the one or more of access points 116 from electronic device 110-1. Alternatively or additionally, the packets or frames may be received by electronic device 110-1 from the one or more of access points 116.

Note that, during the wireless scan, electronic device 110-1 may instruct the one or more of access points 116 to use a common channel. This may allow the one or more of access points 116 to hear the communication traffic (such as one or more packets or frames) to, from or with electronic device 110-1. In some embodiments, electronic device 110-1 may concurrently hear the communication traffic with multiple of access points 116. Moreover, electronic device 110-1 may instruct the one or more of access points 116 to operate in a promiscuous mode. In the promiscuous mode, a given one of the one or more of access points 116 may not drop packets or frames that are addressed to a different access point.

Next, based at least in part on the wireless scan, electronic device 110-1 may generate a wireless-performance map of wireless performance along the path. In some embodiments, the wireless performance may include one or more communication performance metrics, such as an RSSI associated with packets or frames.

Furthermore, based at least in part on the 2D or 3D map of the physical layout of environment 106, electronic device 110-1 may interpolate the wireless-performance map to determine wireless performance in a 2D plane in environment 106. For example, the interpolation may include interpolating or extrapolating the wireless-performance map from the path to a remainder of the 2D plane.

Note that the wireless performance in the 2D plane in environment 106 may exclude reflections. Moreover, the wireless performance in the 2D plane in environment 106 may include signal strength (such as RSSI) as a function of location in the 2D plane.

In some embodiments, in response to receiving information specifying an access point (such as access point 116-1) in the one or more of access points 116, electronic device 110-1 may determine a location of access point 116-1 based at least in part on the 2D or 3D map and distances to at least two other access points in access points 116. For example, the information may include a photograph or image of access point 116-1. Alternatively or additionally, a user of electronic device 110-1 may select access point 116-1 in a user interface displayed on electronic device 110-1. Thus, the information may include a user selection in the user interface.

In these ways, the communication techniques may enable simpler, faster and/or cheaper determination of the wireless performance in the 2D plane in environment 106. Consequently, the communication techniques may provide an improved user experience and may facilitate improved communication performance of a WLAN in environment 106. For example, the communication techniques may facilitate improved design and/or modification of the WLAN, such as moving one or more of access points 116, adding another access point, adjusting the transmit power of one or more of access points 116, etc.

While the preceding discussion illustrated the communication techniques with electronic device 110-1, in other embodiments at least some of the operations in the communication techniques are performed by computer system 112. For example, generating the wireless-performance map of wireless performance along the path may include receiving the wireless-performance map of wireless performance along the path from computer system 112 (which may be cloud-based computer system). Moreover, electronic device 110-1 may provide results of the wireless scan to computer system 112, and/or the one or more of access points 116 may provide one or more reports associated with the one or more of access points 116 with the information for the packets or frames received by the one or more of access points 116 from electronic device 110-1. This information may be used by computer system 112 to generate the wireless-performance map of wireless performance along the path, which is then provided by computer system 112 to electronic device 110-1.

Moreover, while the preceding discussion illustrated the use of the communication techniques with an existing WLAN or network, in other embodiments the communication techniques may be used while the WLAN or network is being designed or implemented. Consequently, in some embodiments, the WLAN or network may only be partially implemented or built when the communication techniques are performed.

In the described embodiments, processing a frame or a packet in a given one of the one or more access points 116 or a given one of the one or more electronic devices 110 may include: receiving wireless signals 126 with the frame or packet; decoding/extracting the frame or packet from the received wireless signals 126 to acquire the frame or packet; and processing the frame or packet to determine information contained in the frame or packet.

Although we describe the network environment shown in FIG. 1 as an example, in alternative embodiments, different numbers or types of electronic devices or components may be present. For example, some embodiments comprise more or fewer electronic devices or components. Therefore, in some embodiments there may be fewer or additional instances of at least some of the one or more access points 116, the one or more electronic devices 110 and/or computer system 112. As another example, in another embodiment, different electronic devices are transmitting and/or receiving frames or packets.

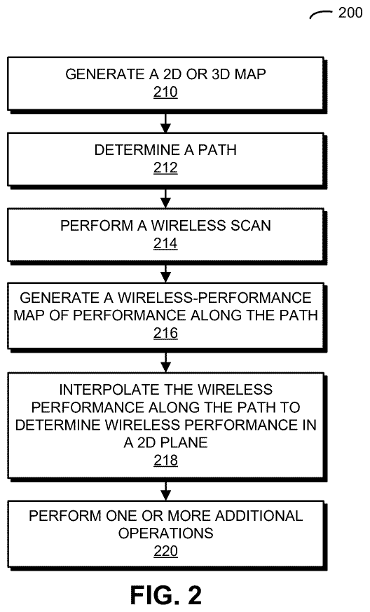

We now describe embodiments of the method. FIG. 2 presents an example of a flow diagram illustrating an example method 200 for determining wireless performance in a 2D plane in an environment. Moreover, method 200 may be performed by an electronic device, such as one of electronic devices 110 in FIG. 1, e.g., electronic device 110-1.

During operation, the electronic device may generate, using an image sensor in the electronic device, a 2D or a 3D map (operation 210) of a physical layout of the environment. Then, based at least in part on the 2D or 3D map of the physical layout of the environment, the electronic device may determine a path (operation 212) of the electronic device in the environment. Moreover, the electronic device may perform a wireless scan (operation 214) of one or more access points in a WLAN, where the wireless scan is performed concurrently with motion of the electronic device along the path. Next, based at least in part on the wireless scan, the electronic device may generate a wireless-performance map of wireless performance along the path (operation 216). Furthermore, based at least in part on the 2D or 3D map of the physical layout of the environment, the electronic device may interpolate the wireless-performance map to determine wireless performance in a 2D plane (operation 218) in the environment.

Note that the electronic device may include a cellular telephone. Moreover, the electronic device may include a LiDAR sensor or an accelerometer, and the electronic device may generate the 2D or 3D map of the physical layout of the environment using the LiDAR sensor or the accelerometer.

Furthermore, the wireless communication may be compatible with an IEEE 802.11 communication protocol.

Note that the wireless performance in the 2D plane in the environment may exclude reflections. Additionally, the wireless performance in the 2D plane in the environment may include signal strength (such as RSSI) as a function of location in the 2D plane.

In some embodiments, the electronic device may optionally perform one or more additional operations (operation 220). For example, during the wireless scan (operation 214), the electronic device may communicate with at least one of the one or more access points. Notably, the electronic device may provide a probe request or a packet to at least the one of the one or more access points.

Moreover, during the wireless scan (operation 214), the electronic device may acquire information specifying wireless signal strength (such as RSSI) for packets as a function of time. For example, the electronic device may receive reports associated with the one or more access points with the information for the packets received by the one or more access points from the electronic device. Alternatively or additionally, the packets may be received by the electronic device from the one or more access points.

Note that, during the wireless scan (operation 214), the electronic device may instruct the one or more access points to use a common channel. This may allow traffic on the common channel to be received by multiple or all of the one or more access points. Moreover, the electronic device may instruct the one or more access points to operate in a promiscuous mode. This may ensure that the a given one of the one or more access points does not drop packets that were addressed to a different access point. Alternatively, in some embodiments, the electronic device may communicate (e.g., transmit pings) with a communication network device in the network while roaming through the network, and the one or more access points may listen to this communication.

Furthermore, generating the wireless-performance map of wireless performance along the path (operation 216) may include receiving the wireless-performance map of wireless performance along the path from a computer system (such as a cloud-based computer system, e.g., computer system 112 in FIG. 1). Additionally, the electronic device may provide results of the wireless scan to the computer system, which may be used by the computer system to generate the wireless-performance map of wireless performance along the path.

Additionally, in response to receiving information specifying an access point in the one or more access points, the electronic device may determine a location of the access point based at least in part on the 2D or 3D map and distances to at least two other access points in the access points. For example, a user of the electronic device may specify the access point by: acquiring an image of the access point; selecting the access point in a user interface, etc.

In some embodiments of method 200, there may be additional or fewer operations. Moreover, there may be different operations. Furthermore, the order of the operations may be changed, and/or two or more operations may be combined into a single operation.

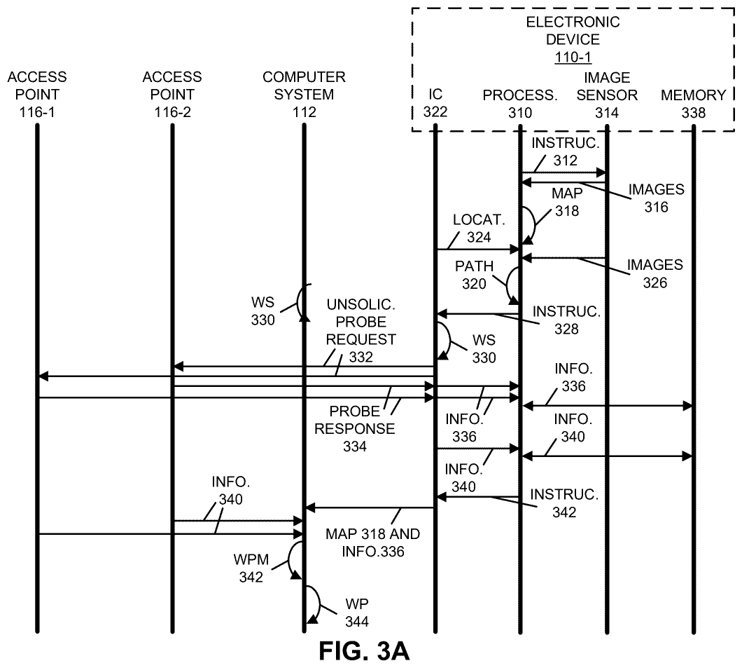

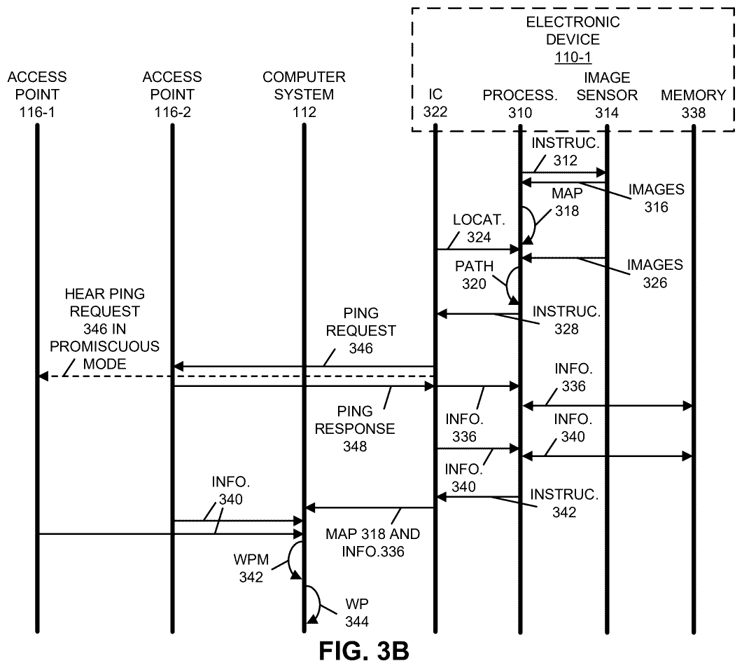

FIGS. 3A and 3B presents a drawing illustrating an example of communication among electronic device 110-1, computer system 112, access point 116-1 and access point 116-2. In FIG. 3A, a processor 310 in electronic device 110-1, which is executing program instructions, may instruct 312 an image sensor 314 (such as a CMOS image sensor, a CCD, an accelerometer and/or a LiDAR sensor) in electronic device 110-1 to acquire images 316 of an environment. Then, processor 310 may generate a 2D or a 3D map 318 of a physical layout of the environment based at least in part on images 316.

Moreover, based at least in part on the 2D or 3D map 318 of the physical layout of the environment, processor 310 may determine a path 320 of electronic device 110-1 in the environment. For example, processor 310 may use locations 324 of electronic device 110-1 (which may be optionally determined by an interface circuit or IC 322 in electronic device 110-1 based at least in part on communication with a cellular-telephone network and/or GPS, and/or additional images 326 acquired by image sensor 314, in conjunction with the 2D or 3D map 318 of the physical layout of the environment to determine path 320).

Furthermore, processor 310 may instruct 328 interface circuit 322 to perform a wireless scan (WS) 330 of access points 116-1 and 116-2 in a WLAN. This wireless scan may be performed concurrently with motion of electronic device 110-1 along path 320. For example, interface circuit 320 may provide an unsolicited probe request 332 to access points 116-1 and 1162, and may provide RSSIs of received probe response(s) 334 from access points 116-1 and 116-2 to processor 310. Note that interface circuit 320 may repeat these operations (e.g., every 0.2 s) during wireless scan 330. However, as shown in FIG. 3B, in other embodiments electronic device 110-1 may ping (such as transmitting a ping request 346) a communication network device (such as one or more of access points 116) in the network (as opposed to performing a wireless scan) and one or more of access points 116 may gather the coverage information, which is then provided to electronic device 110-1 and/or computer system 112 (e.g., in a ping response 348). This may be useful when an operating system of electronic device 110-1 does not allow a low-level scan operation.

in some embodiments processor 310 may store information 336 in memory 338 in electronic device 110-1 during wireless scan 330 or during communication of ping request 346 and ping response 348, such as: RSSI of packets received from access points 116, packet numbers and/or timestamps when the packets were received. Alternatively or additionally, access points 116 may store information 340 during wireless scan 330 or during communication of ping request 346, such as: RSSI of packets received from electronic device 110-1, packet numbers and/or timestamps when the packets were received.

Next, processor 310 may instruct 342 interface circuit 322 to provide the 2D or 3D map 318 of the physical layout of the environment and information 336 to computer system 112. Alternatively or additionally, access points 116 may provide information 340 to computer system 112.

Based at least in part on wireless scan 330 or the communication of ping request 346 and ping response 348, computer system 112 may generate a wireless-performance map (WPM) 342 of wireless performance (such as RSSI) along path 320. For example, computer system 112 may aggregate the reported RSSIs as a function of position of electronic device 110-1 along path 320 into wireless-performance map 342.

Additionally, based at least in part on the 2D or 3D map 318 of the physical layout of the environment, computer system 112 may interpolate wireless-performance map 342 to determine wireless performance (WP) 344 in a 2D plane in the environment. The wireless performance 344 in the 2D plane in the environment may be stored in memory in computer system 112, displayed on a display in computer system 112 and/or provided to another electronic device (such as electronic device 110-1).

While FIGS. 3A and 3B illustrates some operations using unilateral or bilateral communication (which are, respectively, represented by one-sided and two-sided arrows), in general a given operation in FIGS. 3A and 3B may involve unilateral or bilateral communication.

We now further describe the communication techniques.

We now further describe the communication techniques. As discussed previously, it can be difficult, time-consuming and expensive to perform a survey of wireless performance in an environment. In some embodiments, an application executing on an electronic device (such as a cellular telephone or tablet), which may include a camera, an accelerometer and/or a LiDAR sensor, may be used to generate a 2D or a 3D map of a physical layout of an environment (which is sometimes referred to as a ‘floor plan’). For example, using the electronic device, a user may wander around an environment gathering images, acceleration and/or LiDAR data, which may be stored in memory and then sent to a cloud-based computer system. This data may be processed in a service that generates an as-built floor plan. Alternatively or additionally, the floor plan may be generated by the electronic device without sending data to the cloud-based computer system. Note that the floor plan may have an accuracy of 1 ft or less.

Moreover, in the communication techniques, a Wi-Fi survey may be performed along with determining the floor plan. This approach may combine the ease of wandering around with the electronic device with physical location information and wireless performance obtained using the Wi-Fi survey. Thus, as a user or survey taker wanders the environment or space for the purposes of generating a floor plan, the application on the electronic device may send unique wireless packets over the WLAN or network (e.g., ping packets). Moreover, the application may save when each ping was transmitted. This timestamp may uniquely mark a point on the floor plan when the packet was sent. One or more access points, which receive the pings, may send information about the pings (such as the signal strength and potentially information about a second data stream either to a cloud-based computer system or to the application on the electronic device).

In some embodiments, instead of or in addition to the pings, the application may send sounding sequences to get information back about the full channel. The sounding-sequence data may be linked with time-series information about when the electronic device was where during its survey.

Note that, during the survey, the network being surveyed may be put into a special survey mode (e.g., by the electronic device) in which all the access points use a single (common) channel. In this mode, every access point may hear every other access point and any packet sent by the electronic device may potentially be heard by every access point. Alternatively or additionally, every access point may be in a promiscuous capture mode.

Moreover, in the communication techniques, the data may be aggregated by the computer system. Notably, the computer system may combine location information (e.g., from mapping software) with the strength information from the access points. Then, the computer system may generate a heat map overlaying the signal strengths of many access points in the environment.

We now describe embodiments of an electronic device, which may perform at least some of the operations in the communication techniques. For example, the electronic device may: base station 108, one of electronic devices 110, computer system 112, one of access points 116, one of radio nodes 118, and/or switch 128. FIG. 4 presents a block diagram illustrating an electronic device 400 in accordance with some embodiments. This electronic device includes processing subsystem 410, memory subsystem 412, and networking subsystem 414. Processing subsystem 410 includes one or more devices configured to perform computational operations. For example, processing subsystem 410 can include one or more microprocessors, ASICs, microcontrollers, programmable-logic devices, graphical processor units (GPUs) and/or one or more digital signal processors (DSPs).

Memory subsystem 412 includes one or more devices for storing data and/or instructions for processing subsystem 410 and networking subsystem 414. For example, memory subsystem 412 can include dynamic random access memory (DRAM), static random access memory (SRAM), and/or other types of memory (which collectively or individually are sometimes referred to as a ‘computer-readable storage medium’). In some embodiments, instructions for processing subsystem 410 in memory subsystem 412 include: one or more program modules or sets of instructions (such as program instructions 422 or operating system 424), which may be executed by processing subsystem 410. Note that the one or more computer programs may constitute a computer-program mechanism. Moreover, instructions in the various modules in memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 410.

In addition, memory subsystem 412 can include mechanisms for controlling access to the memory. In some embodiments, memory subsystem 412 includes a memory hierarchy that comprises one or more caches coupled to a memory in electronic device 400. In some of these embodiments, one or more of the caches is located in processing subsystem 410.

In some embodiments, memory subsystem 412 is coupled to one or more high-capacity mass-storage devices (not shown). For example, memory subsystem 412 can be coupled to a magnetic or optical drive, a solid-state drive, or another type of mass-storage device. In these embodiments, memory subsystem 412 can be used by electronic device 400 as fast-access storage for often-used data, while the mass-storage device is used to store less frequently used data.

Networking subsystem 414 includes one or more devices configured to couple to and communicate on a wired and/or wireless network (i.e., to perform network operations), including: control logic 416, an interface circuit 418 and one or more antennas 420 (or antenna elements). (While FIG. 4 includes one or more antennas 420, in some embodiments electronic device 400 includes one or more antenna nodes, such as nodes 408, e.g., a pad or connector, which can be coupled to the one or more antennas 420. Thus, electronic device 400 may or may not include the one or more antennas 420.) For example, networking subsystem 414 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 400 may be adapted or changed using pattern shapers (such as reflectors) in one or more antennas 420 (or antenna elements), which can be independently and selectively electrically coupled to ground to steer the transmit antenna radiation pattern in different directions. Thus, if one or more antennas 420 includes N antenna-radiation-pattern shapers, the one or more antennas 420 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 400 may use the mechanisms in networking subsystem 414 for performing simple wireless communication between the electronic devices, e.g., transmitting frames and/or scanning for frames transmitted by other electronic devices.

Within electronic device 400, processing subsystem 410, memory subsystem 412, and networking subsystem 414 are coupled together using bus 428. Bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, electronic device 400 includes a display subsystem 426 for displaying information on a display, which may include a display driver and the display, such as a liquid-crystal display, a multi-touch touchscreen, etc.

Electronic device 400 can be (or can be included in) any electronic device with at least one network interface. For example, electronic device 400 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

Although specific components are used to describe electronic device 400, in alternative embodiments, different components and/or subsystems may be present in electronic device 400. For example, electronic device 400 may include one or more additional processing subsystems, memory subsystems, networking subsystems, and/or display subsystems. Additionally, one or more of the subsystems may not be present in electronic device 400. Moreover, in some embodiments, electronic device 400 may include one or more additional subsystems that are not shown in FIG. 4. Also, although separate subsystems are shown in FIG. 4, in some embodiments some or all of a given subsystem or component can be integrated into one or more of the other subsystems or component(s) in electronic device 400. For example, in some embodiments program instructions 422 are included in operating system 424 and/or control logic 416 is included in interface circuit 418.

Moreover, the circuits and components in electronic device 400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 414 or electronic device 400. The integrated circuit may include hardware and/or software mechanisms that are used for transmitting wireless signals from electronic device 400 and receiving signals at electronic device 400 from other electronic devices. Aside from the mechanisms herein described, radios are generally known in the art and hence are not described in detail. In general, networking subsystem 414 and/or the integrated circuit can include any number of radios. Note that the radios in multiple-radio embodiments function in a similar way to the described single-radio embodiments.

In some embodiments, networking subsystem 414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals) In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 422, operating system 424 (such as a driver for interface circuit 418) or in firmware in interface circuit 418. Alternatively or additionally, at least some of the operations in the communication techniques may be implemented in a physical layer, such as hardware in interface circuit 418.

Additionally, while the preceding embodiments illustrated the use of wireless signals in one or more bands of frequencies, in other embodiments of these signals may be communicated in one or more bands of frequencies, including: a microwave frequency band, a radar frequency band, 900 MHz, 2.4 GHz, 5 GHz, 60 GHz, and/or a band of frequencies used by a Citizens Broadband Radio Service or by LTE. In some embodiments, the communication between electronic devices uses multi-user transmission (such as OFDMA).

In the preceding description, we refer to ‘some embodiments.’ Note that ‘some embodiments’describes a subset of all of the possible embodiments, but does not always specify the same subset of embodiments. Moreover, note that numerical values in the preceding embodiments are illustrative examples of some embodiments. In other embodiments of the communication technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an image sensor configured to acquire one or more images of an environment; and
an interface circuit configured to communicate using wireless communication with one or more access points in a wireless local area network (WLAN), wherein the electronic device is configured to perform operations comprising:
generating, using the image sensor, a two-dimensional (2D) or a three-dimensional (3D) map of a physical layout of the environment;
determining, based at least in part on the 2D or 3D map of the physical layout of the environment, a path of the electronic device in the environment;
performing a wireless scan, wherein the wireless scan is performed concurrently with motion of the electronic device along the path or transmitting packets while the electronic device moves along the path;
generating, based at least in part on the wireless scan or information, received from the one or more access points, specifying a wireless signal strength associated with the packets, a wireless-performance map of wireless performance along the path; and
interpolating, based at least in part on the 2D or 3D map of the physical layout of the environment, the wireless-performance map to determine wireless performance in a 2D plane in the environment.

2. The electronic device of claim 1, wherein the electronic device comprises a cellular telephone.

3. The electronic device of claim 1, wherein the electronic device comprises a LiDAR sensor or an accelerometer, and the 2D or 3D map of the physical layout of the environment is generated using the LiDAR sensor or the accelerometer.

4. The electronic device of claim 1, wherein the wireless communication is compatible with an Institute of Electrical and Electronics Engineers (IEEE) 802.11 communication protocol.

5. The electronic device of claim 1, wherein, during the wireless scan, the operations comprise communicating with at least one of the one or more access points.

6. The electronic device of claim 5, wherein the communication comprises providing a probe request or a packet intended for at least the one of the one or more access points.

7. The electronic device of claim 1, wherein the information specifies the wireless signal strength for the packets as a function of time.

8. The electronic device of claim 7, wherein the operations comprise receiving, from the one or more access points, reports with the information for the packets associated with the electronic device.

9. The electronic device of claim 7, wherein operations comprise receiving second packets associated with the one or more access points with the information.

10. The electronic device of claim 1, wherein, during the wireless scan, the operations comprise instructing the one or more access points to use a common channel.

11. The electronic device of claim 1, wherein, during the transmitting of the packets, the operations comprise instructing the one or more access points to operate in a promiscuous mode.

12. The electronic device of claim 1, wherein generating the wireless-performance map of wireless performance along the path comprises receiving, associated with a computer system, the wireless-performance map of wireless performance along the path.

13. The electronic device of claim 1, wherein the generating the wireless-performance map of wireless performance along the path comprises:
providing results of the wireless scan or the information addressed to a computer system; and
receiving, associated with the computer system, the wireless-performance map of wireless performance along the path.

14. The electronic device of claim 1, wherein, in response to receiving second information specifying an access point in the one or more access points, the operations comprising determining a location of the access point based at least in part on the 2D or 3D map and distances to at least two other access points in the access points.

15. The electronic device of claim 1, wherein the wireless performance in the 2D plane in the environment excludes reflections.

16. The electronic device of claim 1, wherein the wireless performance in the 2D plane in the environment comprises signal strength as a function of location in the 2D plane.

17. The electronic device of claim 16, wherein the signal strength comprises a received signal strength indicator (RSSI).

18. A non-transitory computer-readable storage medium for use in conjunction with an electronic device, the computer-readable storage medium storing program instructions, wherein, when executed by the electronic device, the program instructions cause the electronic device to perform one or more operations comprising:
generating, using an image sensor, a two-dimensional (2D) or a tree-dimensional (3D) map of a physical layout of an environment;
determining, based at least in part on the 2D or 3D map of the physical layout of the environment, a path of the electronic device in the environment;
performing a wireless scan, wherein the wireless scan is performed concurrently with motion of the electronic device along the path, and the wireless scan comprises communication with one or more access points in a wireless local area network (WLAN);
or transmitting packets while the electronic device moves along the path;
generating, based at least in part on the wireless scan or information, received from the one or more access points, specifying a wireless signal strength associated with the packets, a wireless-performance map of wireless performance along the path; and
interpolating, based at least in part on the 2D or 3D map of the physical layout of the environment, the wireless-performance map to determine wireless performance in a 2D plane in the environment.

19. A method for determining wireless performance in a two-dimensional (2D) plan in an environment, comprising:
by an electronic device:
generating, using an image sensor, a two-dimensional (2D) or a tree-dimensional (3D) map of a physical layout of an environment;
determining, based at least in part on the 2D or 3D map of the physical layout of the environment, a path of the electronic device in the environment;
performing a wireless scan, wherein the wireless scan is performed concurrently with motion of the electronic device along the path, and the wireless scan comprises communication with one or more access points in a wireless local area network (WLAN);
or transmitting packets while the electronic device moves along the path;
generating, based at least in part on the wireless scan or information, received from the one or more access points, specifying a wireless signal strength associated with the packets, a wireless-performance map of wireless performance along the path; and
interpolating, based at least in part on the 2D or 3D map of the physical layout of the environment, the wireless-performance map to determine the wireless performance in the 2D plane in the environment.

20. The method of claim 19, wherein the 2D or 3D map of the physical layout of the environment is generated using a LiDAR sensor or an accelerometer in the electronic device.
